(19) United States
(12) Patent Application Publication
(10) Pub. No.: US 2007/0250571 A1
(43) Pub. Date: Oct. 25, 2007

(54) Method and apparatus for interfacing a network with a television or stereo for enhanced access of media content

(76) Inventor: Paul P. Griffin JR., Nasville, TN (US)

Correspondence Address: Jason L. Hornkohl, P.O. Box 210584, Nashville, TN, 37221, US

(21) Appl. No.: 11/726,794

(22) Filed: Mar. 23, 2007

Related U.S. Application Data
(63) Continuation-in-part of application No. 11/400,414, filed on Apr. 7, 2006.

(51) Int. Cl. G06F 15/16

(52) U.S. Cl. 709/204

(57) ABSTRACT

A media device interfaces a television with the Internet and a computer such that media content discovered with a computer can be retrieved from the Internet by the device for display on the television. An instant message or chat interface is used to receive the digital content from an instant message or chat client. The user specifies accounts that are authorized to send content to the device through the instant message interface. The user can also specify full access accounts that can be used to remotely configure and control the device. The media device automatically retrieves authorized media content from the instant message client and stores it in directories. The media files in the directories can then be accessed through a menu displayed on the television by a user manipulating the menu.

### CROSS-REFERENCES TO RELATED APPLICATIONS

This application is a Continuation-In-Part application which claims benefit of co-pending U.S. patent application Ser. No. 11/400,414 filed Apr. 7, 2006, entitled “Method and Apparatus for Interfacing a Network with a Television for Enhanced Access of Media Content” which is hereby incorporated by reference.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### FIELD OF THE INVENTION

The present invention is generally directed toward a device and method for acquiring media content both from a local network and from the Internet for display on a television. More particularly, the present invention is directed toward an instant message or chat interface system that allows digital content to be automatically downloaded from the Internet via an instant message or chat interface.

### BACKGROUND OF THE INVENTION

With the proliferation of broadband, next generation P2P (peer-to-peer), and XML RSS, the Internet is becoming an increasingly viable medium for the distribution and consumption of digital media. Media consumers increasingly want to view audio and audio visual content gleaned from the Internet on their TVs. A recent survey found that while 25% of Internet users like watching video content on their PCs, 38% would prefer to watch the same content on their TVs. While there are a number of devices on the market that aim to either connect the PC to the TV, or to connect the TV directly to the Web, none has been very reliable, user-friendly, or successful in the market. One of the reasons for these devices' failure in the marketplace is that none of the devices is optimized for the two main methods by which users acquire data-intensive media content from the Internet-BitTorrents and podcasts.

BitTorrent refers to a peer-to-peer (P2P) file distribution client application and the file sharing protocol itself. The BitTorrent protocol is designed to widely distribute large amounts of data, in the form of torrents, without consuming large amounts of costly server and bandwidth resources. BitTorrent accomplishes this by relying on many PC-based client/servers, “peers,” in place of centralized, dedicated servers. BitTorrent users download torrent files which tell their client which server to look on for information on how to connect to other users to receive torrent files. Although any type of media could be distributed via BitTorrent, the vast majority of torrent content today is video files. Media content is typically distributed using BitTorrents as follows. First a user assembles the files that they want to release, starts a tracker on a server and generates a .torrent file. The .torrent file is then submitted to Web sites. A user goes to one of these Web sites, locates the media file they are interested in downloading, and clicks on the torrent link. The torrent file is downloaded, and the file is passed to the user's BitTorrent client. The client then uses the torrent file to locate the tracker for the BitTorrent media file. The client then contacts the tracker, which gives the client a list of other users that are currently downloading the file, and adds the user making the request to this list. After the client has obtained this list, it contacts those other users, and tries to download the file from them. If the user's client is “sharing,” then other users will share with it. As the user is downloading the file, their client will be contacted by other clients, and parts of the file will be uploaded to them. Because the pieces of the file are downloaded in random order, all of the pieces of the file will be distributed quickly. Once the pieces are all downloaded they are reassembled into the complete media file.

Podcasting is the distribution of audio or video files, such as radio-style programs or video news casts, over the Internet using either RSS or Atom Web feed formats to mobile devices and personal computers. A podcast is a Web feed of audio or video files placed on the Internet for individuals to download or subscribe to. The ability to subscribe to a “channel” of automatically delivered content is what distinguishes a podcast from a simple download or real-time streaming. Usually, a podcast features one type of “show,” with new episodes made available at planned intervals such as daily, weekly, etc.

Instant messaging clients, and chat clients which are essentially public instant messages, allow users to transmit text messages and digital files to designated buddies or authorized users. These messaging systems are very widely used and accessible through a wide variety of devices. Unfortunately, these instant messaging systems are not designed to deliver digital content to a user's television of stereo. In addition, the presently available television/Internet interface devices are prohibitively costly and have severe limitations on the types of file formats they can handle. None of the currently available solutions provides a coherent, smoothly integrated connection between the PC, media interface device, and TV. Therefore, what is needed is an improved method and device for displaying media files retrieved from a local network or the Internet on a television.

### BRIEF SUMMARY OF THE INVENTION

An embodiment of the present invention is directed toward an apparatus for displaying digital content on a television or playing music over a stereo. The apparatus includes an instant message interface that receives and sends digital content through an instant message client and displays the content on the television or plays the content on the stereo. The apparatus also includes application software on a computer for retrieving media files, torrent files and podcast identifiers from a local network or the Internet and pushing the media files, torrent files and podcast RSS feed addresses from the computer to the apparatus. The interface includes application software that allows a user to authorize selected instant message users to download content to the apparatus. The application software allows the user to authorize limited access to some authorized users and full access to other authorized users. The full access authorized users can configure the apparatus through the instant message client on a remote terminal. A menu generator generates a menu on the television that can be manipulated to selectively display digital content stored in the apparatus on the television. The instant message interface also has a search routine for searching metadata associated with the digital content and allows a user to limit an amount of available bandwidth for use in downloading digital content to the apparatus.

Another embodiment of the present invention is directed toward a device for converting digital media files received from a computer to a format capable of being played on a television and downloading information from the Internet. The device includes an instant message or chat interface that receives digital media files from an instant message or chat client such that the digital media files can be displayed on a screen of the television or played on a speaker of the television. Download management software allows a user to select digital content for downloading from the instant message or chat client and specify an amount of available bandwidth for use in downloading the digital content. A buddy list includes a list of users of the instant message or chat client that are authorized to send digital content to the device. Preferably, at least a portion of the instant message or chat interface resides on a computer coupled to the device. A video encoder and graphics processor convert the digital content into a television format for display on the television.

Yet another embodiment of the present invention is directed toward a method for receiving digital content system from the Internet for playback on a television or stereo. In accordance with the method, an instant message account is created. Digital content sent to the instant message account is automatically received with an interface device that can playback the digital content on the radio and television. The interface device includes a video encoder and graphics processor for converting the digital content into a television format for display on the television. Instant message accounts are authorized such that only authorized instant message accounts can send digital content to the interface device. The amount of available bandwidth for use in downloading the digital content to the interface device may be selectively limited by a user. A menu generator generates a menu of digital content accessible by the interface device that is preferably displayed on the television. A message associated with the downloaded digital content is also preferably displayed on the television. The interface device also preferably includes an assembler for assembling a torrent file.

Yet another embodiment of the present invention is directed toward an apparatus for interfacing a computer with a television. An S-video output and an S-video input connect the apparatus to the television. The apparatus preferably communicates with the computer over a wireless network. The computer has application software that allows a user to retrieve media files, torrent files and podcast identifiers from a local network or the Internet and push the media files, torrent files and podcast identifiers from the computer to the apparatus. The apparatus also has media file software that receives media files from the computer and formats the media files for playback on the television. BitTorrent file software in the apparatus receives torrent files from the computer, uses the torrent files to download media files in the form of torrents from a network and formats the downloaded media files for playback on the television. Podcast software receives a podcast resource identifier from the computer, downloads a podcast identified by the identifier from a network and formats the downloaded podcast file for playback on the television. Streaming audio software receives streaming audio from a network and formats the streaming audio for playback over the television. The apparatus includes storage for storing the files received from the computer and from the Internet. A video encoder and graphics processor are used to format the media files, torrent files, podcast files, and streaming audio to be played on the television. A menu generator generates a menu on the television that can be manipulated by a remote control to selectively display media content stored in the apparatus on the television.

Yet another embodiment of the present invention is directed toward a device for converting media files received from a computer to a format capable of being played on a television and downloading information identified by the computer from the Internet. The computer contains application software that allows a user to locate podcasts and torrent files and transfer information specifying a location of the podcasts and the torrent files to the device. The device includes an aggregator for collecting podcasts and formatting the podcasts for playback on the television. The aggregator maintains a list of feed subscriptions and downloads enclosures as they become available. A BitTorrent file client receives torrent files, downloads and assembles media files associated with the torrent files and formats the media files for playback on the television. The BitTorrent file client in the device also seeds the torrent files for at least one other torrent peer. A streaming audio client receives a streaming audio Webcast from the Internet, plays the streaming audio Webcast over the television and displays audio meta data corresponding to the streaming audio Webcast on the television. A video encoder and graphics processor convert the podcasts and the torrent files into a television format for display on the television.

Yet another embodiment of the present invention is directed toward a system for providing media content downloaded from the Internet on a television. The system includes a computer having application software for locating media content identifiers (URIs) that specify a location of a podcast or torrent file on the Internet. An interface device receives the media content identifiers from the computer, downloads the podcast or torrent file specified by the media content identifiers from the Internet and displays media content associated with the podcast or the torrent file on a television. The interface has an aggregator for collecting the podcasts and an assembler for assembling the torrent files. The interface device also has a streaming audio client that receives streaming audio content from the Internet, plays the streaming audio content on the television and displays metadata associated with the streaming audio content on the television. The interface device has a video encoder and graphics processor that convert the podcast or the torrent file into a television format for display on the television. Storage in the interface device is used to store podcasts and torrent files such that the files can be selectively displayed on the television. A menu generator generates a menu of media files stored in the device that is displayed on the television and manipulated with a remote control to select the desired file.

### BRIEF DESCRIPTION OF THE SEVERAL VIEWS OF THE DRAWINGS

FIG. 1 is a system diagram of an Internet and TV interface device constructed in accordance with an embodiment of the present invention;

FIG. 2 is a functional block diagram of a computer for use with a media interface device constructed in accordance with an embodiment of the present invention;

FIG. 3 is a functional block diagram of a media device constructed in accordance with an embodiment of the present invention;

FIGS. 4(a) and (b) are diagrams of a preferred user interface for an instant message or chat client interface for a media device constructed in accordance with an embodiment of the present invention;

FIGS. 5(a) and (b) are pictorial illustrations of instant message or chat interface screens for a media device constructed in accordance with an embodiment of the present invention;

FIGS. 6(a) and (b) are pictorial illustrations of buddy management interface screens for a media device constructed in accordance with an embodiment of the present invention; and

FIG. 7 is a pictorial illustration of an advanced user interface screen for a media device constructed in accordance with an embodiment of the present invention.

### DETAILED DESCRIPTION OF THE INVENTION

The present invention allows users to discover media content in the same manner that they are already accustomed to, i.e. by searching Websites, including directories of torrent files and podcast feeds with their personal computer. Once the desired media content has been discovered with the PC, users can push that content, or push directions, i.e. Uniform Resource Identifiers (URIs), for where to obtain the content, from the PC to the interface device. In the latter case, the interface device will pull specified content directly from the Internet, based upon selections made by the user of the PC. The device may utilize an instant message or chat interface to retrieve the digital content from the internet such that a user can share digital content with their friends and family.

A preferred embodiment of the present invention preferably performs four main functions. First, the device stores media files, transferred over the user'local network from a PC, and plays them on a connected television. Second, the device downloads media files from the Internet associated with torrent files, stores the media files, seeds them for other BitTorrent peers, and plays them on the connected television. Third, the device runs an RSS aggregator, also known as a podcatcher, which maintains a list of feed subscriptions and downloads all available enclosures. The device then downloads and stores media files from user-specified podcast feeds, and plays them on the connected television. Finally, the device runs a client that streams audio from a streaming audio provider such as the SHOUTcast network and displays music metadata on the connected television while the streaming audio is playing. The device displays a menu on the television that a user can manipulate with a remote control to access the various media. The device can also advantageously send or receive digital content through an instant message or chat client. The combination of functions set forth above provides a more user-friendly interface between the local and external networks and a television and, thus, is a substantial improvement upon the prior art.

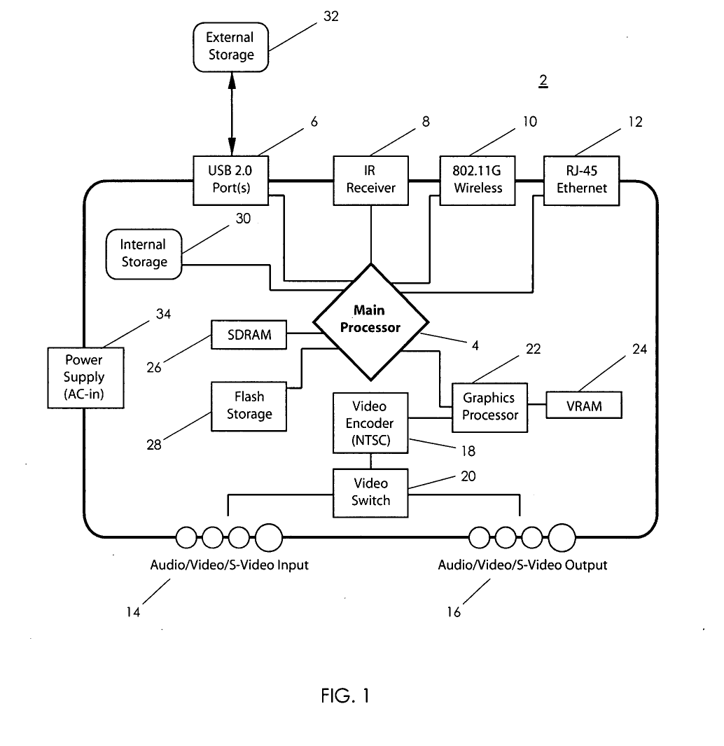

Referring now to FIG. 1, a system diagram of an Internet and TV interface device 2 constructed in accordance with an embodiment of the present invention is shown. The device is managed by a main processor 4 that receives and sends digital data through a series of input/output ports 6, 8, 10 and 12. These ports can include a USB port 6, an infrared receiver 8, a wireless radio frequency transceiver 10 and an Ethernet connection 12 among others. These inputs are used to connect the device 2 to a computer such that data can be retrieved from the computer and from the Internet so that the device can download information directly from the Web. An audio/video/S-video input 14 and an audio/video/S-video output 16 are used in conjunction with a video encoder 18 and switch 20 to interface the device 2 with a standard television. Although a standard television interface is generally preferred for cost reasons, a high definition television interface could be utilized if desired. A graphics processor 22 and video random access memory 24 are used to convert the digital media data into a form that can be displayed on the television. SDRAM 26, flash storage 28 and additional internal 30 and external storage 32 are used by the main processor 4 to store downloaded media files as needed. While a variety of storage devices 26, 28, 30 and 32 are shown in FIG. 1, those skilled in the art will recognize that the device could use any single type or combination of the storage means shown and all of the storage and processing components shown in FIG. 1 could be constructed on a single chip or computer board if desired. The main processor 4 uses aggregating software to collect podcasts and assembling software to assembly torrents into the desired media files. An external or internal power supply 34 provides the device with the power needed to run the various components.

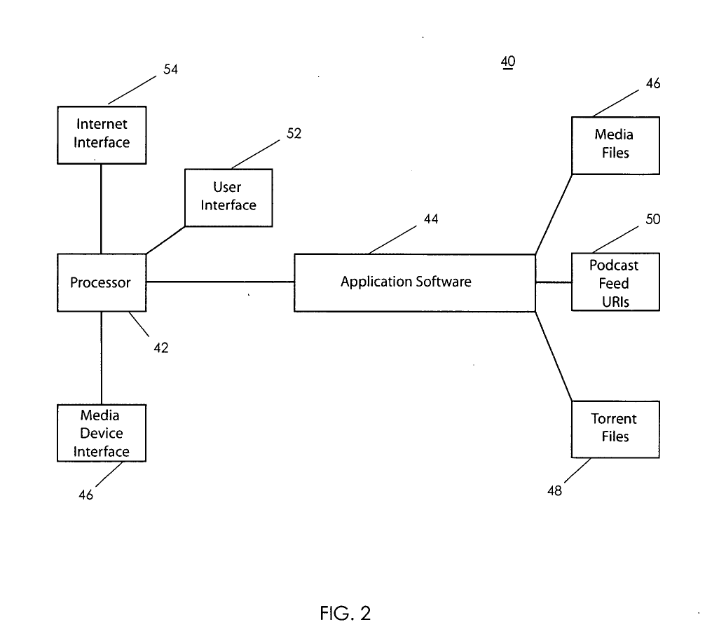

Referring now to FIG. 2, a functional block diagram of a computer 40 for use with a media device constructed in accordance with an embodiment of the present invention is shown. The computer 40 has a processor 42 that runs PC application software 44 that pushes content to the media device 2 shown in FIG. 1 through a device interface 46. The device interface 46 couples the computer 40 to the media device over a local network via a local server such as WebDAV or Samba. The PC application software 44 is preferably optimized to handle three types of content: media files 46 (audio and video); torrent files 48 and podcast feed URIs (Uniform Resource Identifiers) 50. The application software 44 uses a user interface 52 that provides users with a clear means of transferring content (i.e., media files) and content locators (e.g., torrent files and podcast feed URIs), retrieved from the Internet through an Internet interface 54 of the computer 40 into the appropriate directories within media device. These directories are preferably organized into sub directories named “Music,” “Videos,” “Torrents,” “Podcasts,” and “Web Radio.” Users populate the “Music” and “Videos” directories by transferring content (media files 46) directly from the PC to media device. By contrast, users would populate the “Torrents” and “Podcasts” directories indirectly, by transferring content indicators (i.e., torrent files 48 or podcast feed URIs 50), from the personal computer 40 to the media device. Most preferably, the interface 54 also allows the device to utilize an instant message or chat client to send and retrieve digital content through the Internet as discussed in more detail herein.

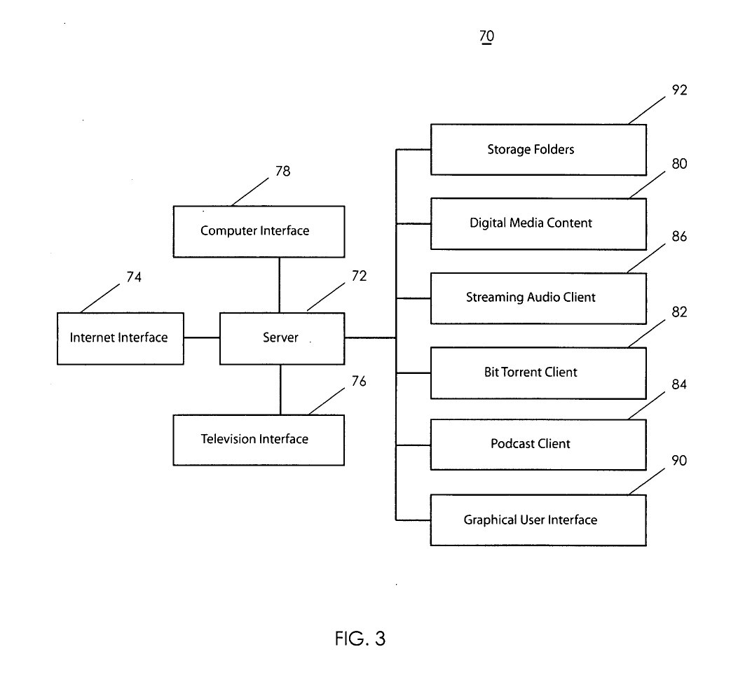

Referring now to FIG. 3, a functional block diagram of a media device 70 constructed in accordance with an embodiment of the present invention is shown. The media device 70 preferably runs Linux but can use any type of operating system that is preferred. The device 70 is managed by a server 72 that interfaces the device to the Internet 74, a computer 78 and a television 76. The media device 70 is preferably capable of handling four types of media content: digital media files 80 (audio and video); torrent files 82; podcast feed URIs 84 and streaming audio URIs 86. Thus, the media device 70 will functionally contain a file server 72, a BitTorrent client 82, a podcatcher (RSS with enclosures aggregator) or podcast client 84, a streaming audio client 86, and a digital media client 80. The digital media client 80 may further include an instant message client as discussed in more detail below. The device 70 integrates these elements, which are primarily implemented through software, into a unified whole that is accessible through a coherent graphical user interface 90 displayed on the television. For cost minimization purposes, the media device will preferably only handle standard definition video. However, those skilled in the art will recognize that the device can also be readily adapted for use with high definition television with few modifications required.

Upon receiving the torrent files or podcast feed URIs from the computer, the media device 70 will commence pulling the associated content from the Internet and populating the appropriate directories. Finally, the media device will pull a list of “Web Radio” stations URIs (Uniform Resource Identifiers) from an Internet radio network, such as the SHOUTcast network, without the need for a directory or user intervention on the PC side. After a user has configured the media device 70 to receive the desired media content through the personal computer, all of the selected content stored in a set of storage folders (directories) 92 will be browsable on the user's TV, via a remote control, within correspondingly named top-level directories: “Music,” “Videos,” “Torrents,” “Podcasts,” and “Web Radio.” While these directories are preferred, additional directories can be added if desired.

The device is primarily aimed at consumers already acquainted with BitTorrent, podcasting, and Web radio. Nevertheless, the device does not require any expertise on the part of users beyond Web browsing, P2P, podcasting, and installing consumer-grade wireless routers. For users acquainted with BitTorrent and podcasting, the device should be simple to use. While the media device is capable of functioning like any server, this functionality is preferably hidden from the casual user to increase the user friendless of the device. Indeed, for the casual user, the functioning of the device will be simple, and unidirectional: “Discover content with your PC. Experience it on your TV.”

A most preferred embodiment of the present invention allows an individual to download digital content such as BitTorrent files, videos, music, and photos onto an existing TV and stereo, from any personal computer by using their favorite instant messaging program such as AIM, Yahoo, Google Talk, or iChat to transfer torrents, videos, music, and photos to the media device. Application software resides in the users “buddy list”—or contact directory. In the instant messaging world, instant messaging users that are authorized to send messages to particular user are referred to as “buddies” of the user. When the user decides to download content to their media device, they simply access the buddy contact associated with the device and then send digital content to their media device through the instant messaging interface. Thus, a media device constructed in accordance with an embodiment of the present invention promotes social exchanges by allowing a user's friends and family to exchange digital content through their instant messaging interfaces and use the media device to transfer the digital content to their television or stereo. The user simply adds their friends′ media devices to their buddy list in a chat or instant message context such as Griffin Chat™, AIM™, Yahoo™, Google Talk™, or iChat™. Once the devices have been added to their buddy list, the user can share digital content in the form of torrents, videos, music, and photos with anyone in their social network that owns a compatible media device without requiring that the recipient's active participation. When content such as a torrent file is transferred to a specified media device, the media device automatically downloads the content from the BitTorrent network. When the recipient turns on their TV, the media device notifies them that new content has arrived.

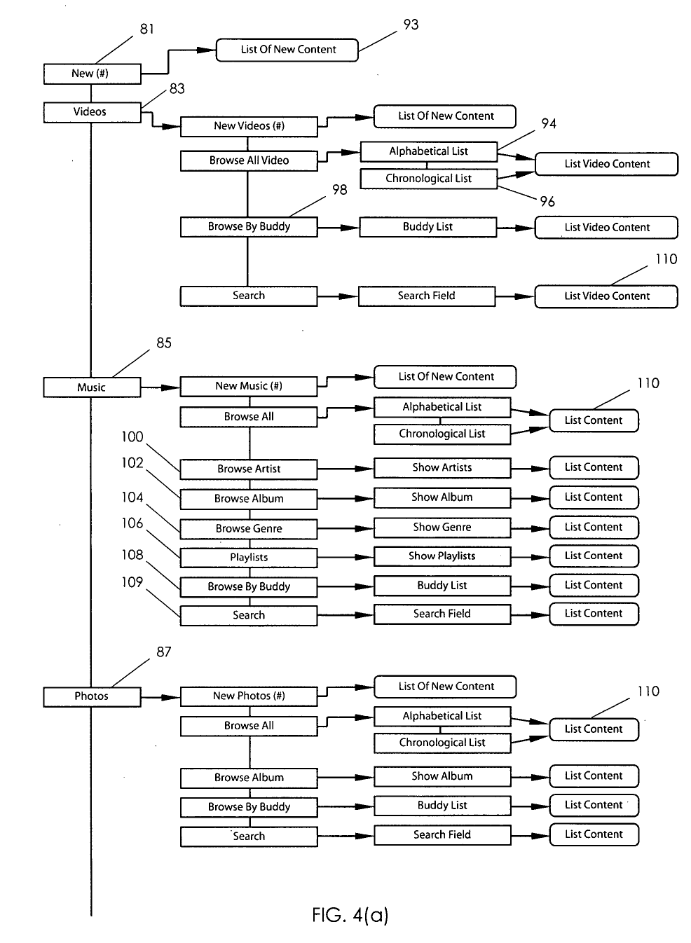

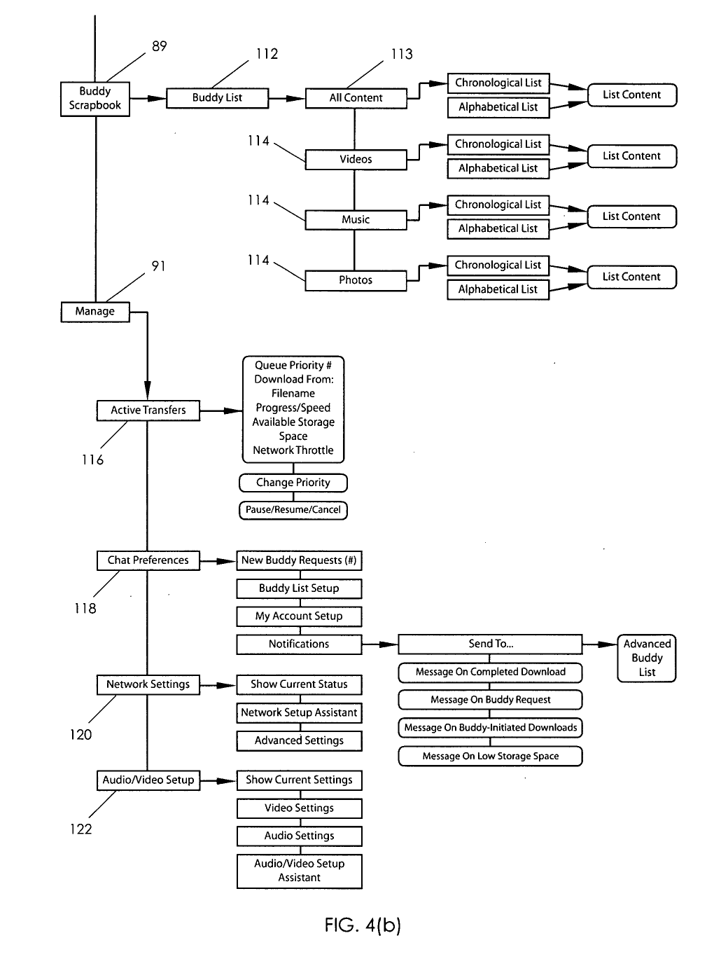

Referring now to FIGS. 4(a) and (b) a menu diagram of a preferred instant message or chat interface for a media device constructed in accordance with an embodiment of the present invention is shown. The start up screen of the device provides the user with a number of selections. The preferred selections are new content 81, videos 83, music 85, photos 87, buddy scrap book 89 and a management interface 91. If the user selects the new content menu selection 81, a list of new content 93 that the user has yet to access is displayed. In a similar manner, if the user selects the video selection 83, a set of video options is displayed. The video options preferably include the ability to search videos alphabetically 94, chronologically 96 or by the buddy 98 from which the content was received. The music selections 85 preferably can be searched by artist 100, album 102, genre 104, playlist 106 or buddy 108. A search selection 109 can be used to enter a search term to search file metadata and retrieve content associated with the search term. Once the use makes their selection, a list of the selected content 110 is displayed so that the user can play the selection on their television or stereo.

The buddy scrap book 89 allows the user to review a buddy list 112 and select content arranged according to the buddy from which the content was received. If a user chooses to browse by buddy scrapbook 89, a list of buddies who have sent content to the media device is shown. Once a buddy has been selected, the content may be further divided according to further sub-categories 114 such video, music or photographs. For example, if the user wants to view all of the digital content, which includes photos as well as short videos, sent from a particular buddy, the user first chooses the friend's name from the buddy list 112. The user can then choose to view all of the digital content that the friend has sent, or selectively view just the videos, music, or photos. If the user wants to see a complete list of the friend's photos and videos, they can choose an “All Content” 113 menu option.

The management menu selection 91 provides the user the ability to control the various functions of the chat interface such as active transfers 116, chat preferences 118, network settings 120 and audio/video setup features 122. The active transfers selection 116 allows the user to manage, prioritize and monitor downloads and set a limit for the amount of bandwidth dedicated to the transfers as discussed in more detail herein. The chat preferences selection 118 allows the user to review new buddy requests, set up an account, and send notifications to accompany transferred digital content. When a user uses a chat interface to send torrents, videos, music, or photos to the media device, or to a buddy's device, the user is given the opportunity to supply identifying information about that content. For example, the user can send a short message to accompany an individual digital file or a group of files if they are sending a folder containing multiple files. The short message reminds the user why a file, or group of files, is important. For example, a short message such as “Hi Mom, here are the pictures of the kids” may be attached to a digital file containing pictures. The short messages are stored along with the file(s) that the user has sent, and remain on the recipient's device with the files they accompany. When a file is selected from a menu in the device's media library, the short message belonging to it will appear beside the file.

The content that the media device displays resides on the user's computer and is identifiable on the media device by name, category and file metadata. If the user chooses to install included media server software on a computer connected to their home network (Mac or PC), any videos, music, or photos stored on that computer's hard drive will show up in the media device media libraries. The user is then able to access those files on the media device as long as the computer on which they're stored is connected to their home network. If the computer is turned off, or removed from the home network, any files that reside on the computer will be unavailable for display or playback on the device. However, when the computer is reconnected to the home network, those files will automatically reappear in the device's media library.

The network settings 120 selection allows a user to view the network settings and access a setup assistant. In a similar fashion, the audio/video setup selection 122 allows the user to manage the audio and video settings of the interface and the device and access a setup assistant. The particular menu selections shown in FIGS. 4(a) and (b) are preferred menus only and a variety of different menu formats and selections can be used in accordance with various embodiments of the present invention.

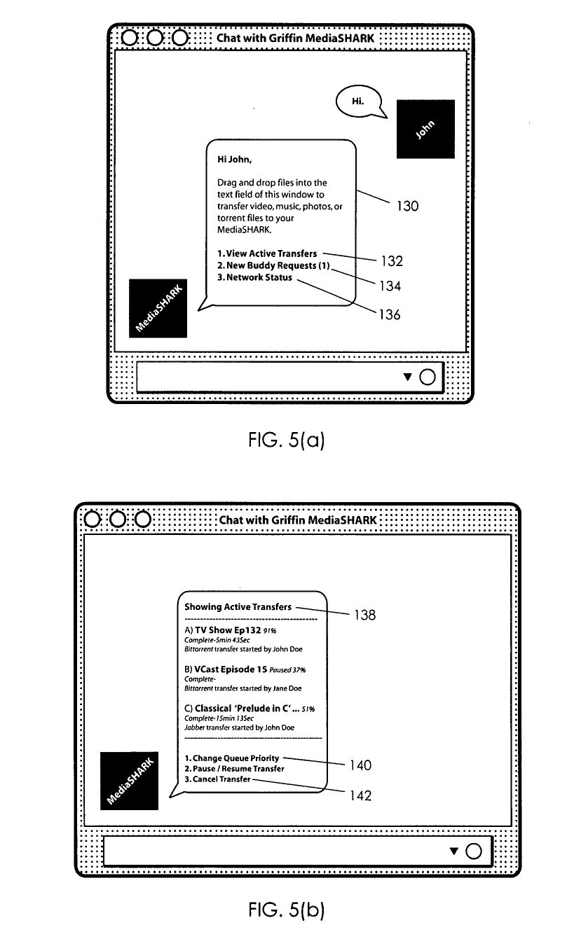

Referring now to FIGS. 5(a) and (b), a pictorial representation of a chat interface for a media device constructed in accordance with an embodiment of the present invention is shown. When a user powers up the media device for the first time, a network setup assistant 130 will help the user connect the media device to their home network and the Internet. The user will also be prompted to set up a media device chat or instant message account. An on-screen keyboard is preferably used to select a name for the user's media device. If the name chosen has already been selected by someone else, the user will be prompted to choose a different name. Once the user has chosen a unique chat name for their device, the basic setup is complete. The user then uses the chat name given to the device and a chat program such as Griffin Chat™(or any other Jabber™compatible chat program, like iChat, Adium™, or Google Talk™) to add the device to their buddy list. The user now has access to the media device from anywhere access to the chat program is available. The user can send torrents, videos, music, and photos to the device from a personal computer at home, at work, while traveling or at school. As shown in the preferred display of FIG. 5(a), through chat, the user can drop and drag files into a graphical window 130 to transfer the files to the device. The user can also check on the progress of downloads 132, and manage their buddy list 134, check the network status 136, and manage the other device functions described herein through a menu driven interface. When a menu selection such as “View Active Transfers” 132 is selected an expanded set of menu selections and status data is preferably displayed as shown in FIG. 5(b). In the “View Active Transfers” screen, the user can preferably view the status of downloads 138, change download priorities 140, and cancel transfers 142.

When digital content is sent to the media device, the device automatically begins to download the content. When the download is complete, the device notifies the user that a new content is available with a message on their TV screen. If the content was sent by a buddy, the notification specifies which buddy sent the content. If the file is a torrent, the device automatically begins to download the media file associated with it, and notifies the user that new content is available only after the entire media file has been downloaded. At any time the user can navigate to the “Active Transfers” menu on the device, FIG. 5(b), where they can observe what files are currently downloading, both those transfers that the user initiated and those that were initiated by a buddy. Since the digital content is sent automatically in small packets, large files that might be rejected from an email server can be transferred with no problem with an interface constructed in accordance with an embodiment of the present invention. From the “Active Transfers” menu the user can check the progress of file transfers, and discontinue transfers. They can also check what media files the device is sharing on the BitTorrent network, stop sharing specific files, and throttle the bandwidth that the device is using to share files.

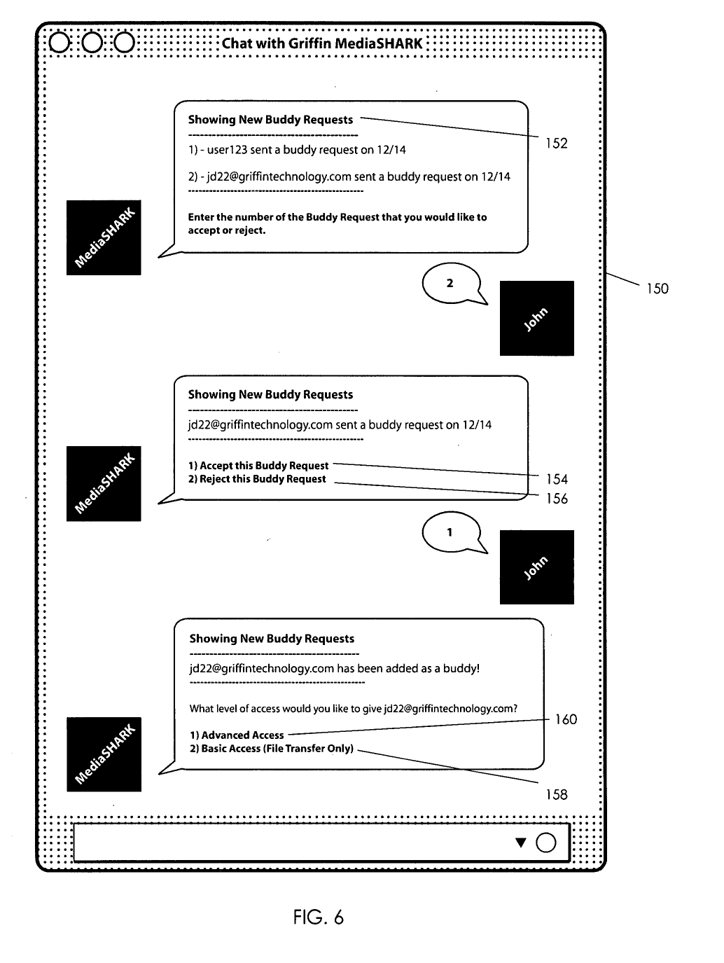

The media device promotes social interaction by allowing people, “buddies,” to send digital content to each other's media device as long as they have a compatible instant message or chat account. A preferred buddy management interface screen 150 is shown in FIG. 6. If a user wants a friend to have access to their device, they simply have their friend send an instant message to their media device. To do this the friend must know the device's chat name. The first time a new person sends an instant message to the device, the device responds by asking that person if they would like to send the device's owner a buddy request. The device notifies the user of any new buddy requests through the chat interface 152. The user can then navigate to the “Chat Preferences” menu, preferably with an on screen keyboard or remote control, and either accept 154 or deny 156 that request. Preferably, only individuals whose buddy requests have been accepted are allowed to send files to the user's media device. In the embodiment shown, buddies that have been designated as “Basic Users” 158 have limited access—they may send files to the user's media device (i.e., torrents, videos, music, and photos), but they do not have access to managerial functions. Buddies to whom the user has given “Advanced User” access 160 are able to manage the media device through the instant message interface as well as to transfer files. Thus, only authorized buddies can send digital content to the user's media device and control the device's functions. If the user wants to change the level of access granted to a buddy, they simply navigate to the “Chat Preferences” menu, where they can add and delete buddies, change a buddy's access level (Basic or Advanced User), and change a buddy's alias (personal name) as described in more detail herein.

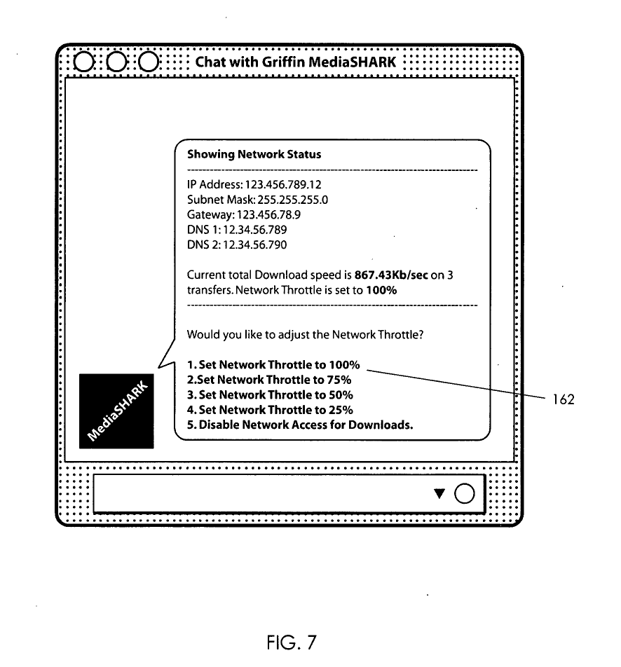

When the media device is accessed from a Chat account to which Advanced User access has been given, the user will have access to managerial functions of the media device. An Advanced User preferably gets full control over the media device. They can transfer files, browse new files, check the progress of current file transfers, pause or discontinue file transfers, limit the bandwidth available 162 to the media device on their home network as shown in FIG. 7, or manage their buddy lists.

In accordance with a preferred embodiment of the present invention, a user can assign aliases to their buddies. For example, “John H.” might have the chat name “jh3245@abc.com” but be assigned the alias “John H” by the device's user. Thus, when jh3245@abc.com sends a file to the device, the device will show that the file was sent by “John H.”

Although there have been described particular embodiments of the present invention of a new and useful METHOD AND APPARATUS FOR INTERFACING A NETWORK WITH A TELEVISION OR STEREO FOR ENHANCED ACCESS OF MEDIA CONTENT, it is not intended that such references be construed as limitations upon the scope of this invention except as set forth in the following claims.

What is claimed is:

1. An apparatus for displaying digital content on a television or playing music over a stereo, the apparatus comprising:
an instant message interface that receives and sends digital content through an instant message client and displays said content on said television or plays said content on said stereo.

2. The apparatus of claim 1 wherein said apparatus further comprises application software on a computer for retrieving media files, torrent files and podcast identifiers from a local network or the Internet and pushing said media files, torrent files and podcast RSS feed addresses from said computer to said apparatus.

3. The apparatus of claim 1 wherein the interface further comprises application software that allows a user to authorize selected instant message users to download content to the apparatus.

4. The apparatus of claim 3 wherein the application software further allows said user to authorize limited access to some authorized users and full access to other authorized users wherein said full access authorized users can configure said apparatus through said instant message client.

5. The apparatus of claim 1 wherein said instant message interface further comprises a menu generator for generating a menu on said television that can be manipulated to selectively display digital content stored in said apparatus on said television.

6. The apparatus of claim 1 wherein said instant message interface further comprises a search routine for searching metadata associated with said digital content.

7. The apparatus of claim 1 wherein said instant message interface allows a user to limit an amount of available bandwidth for use in downloading digital content to said apparatus.

8. The apparatus of claim 1 wherein a user can configure said apparatus through an instant message interface on a remote terminal.

9. A device for converting digital media files received from a computer to a format capable of being played on a television and downloading information from the Internet, said device comprising:
an instant message or chat interface that receives digital media files from an instant message or chat client such that said digital media files can be displayed on a screen of said television or played on a speaker of said television.

10. The device of claim 9 further comprising download management software that allows a user to select digital content for downloading from said instant message or chat client and specify an amount of available bandwidth for use in downloading said digital content.

11. The device of claim 9 further comprising a buddy list that includes a list of users of said instant message or chat client that are authorized to send digital content to said device.

12. The device of claim 9 wherein at least a portion of said instant message or chat interface resides on a computer coupled to said device.

13. The device of claim 9 further comprising a video encoder and graphics processor for converting said digital content into a television format for display on said television.

14. A method for receiving digital content system from the Internet for playback on a television or stereo, said method comprising the steps of:
creating an instant message account; and
automatically receiving digital content sent to said instant message account with an interface device that can playback said digital content on said radio and television.

15. The method of claim 14 wherein said interface device further comprises a video encoder and graphics processor for converting said digital content into a television format for display on said television.

16. The method of claim 14 further comprising the step of authorizing instant message accounts such that said authorized instant message accounts can send digital content to said interface device.

17. The method of claim 14 further comprising the step of limiting an amount of available bandwidth for use in downloading said digital content to said interface device.

18. The method of claim 14 wherein said interface device further comprises a menu generator that generates a menu of digital content accessible by said interface device.

19. The method of claim 14 further comprising the step of displaying a message associated with downloaded digital content on said television.

20. The method of claim 14 wherein said interface device further comprises an assembler for assembling a torrent file.
